(19) United States
(12) Patent Application Publication
(10) Pub. No.: US 2024/0248673 A1
(43) Pub. Date: Jul. 25, 2024

(54) Digitally Controlled Microphone with Audio Compressor

(71) Applicant: APOGEE ELECTRONICS CORPORATION, Los Angeles, CA (US)

(72) Inventor: Lucas Van der Mee, Los Angeles, CA (US)

(21) Appl. No.: 18/624,610

(22) Filed: Apr. 2, 2024

Related U.S. Application Data
(63) Continuation-in-part of application No. 18/106,347, filed on Feb. 6, 2023.
Application No. 18/106,347 is a continuation of application No. 17/062,627, filed on Oct. 4, 2020, now Pat. No. 11,720,316.
Application No. 17/062,627 is a continuation of application No. 16/559,607, filed on Sep. 3, 2019, now Pat. No. 10,838,683.
(60) Provisional application No. 62/793,841, filed on Jan. 17, 2019.

(51) Int. Cl. G06F 3/16; G10L 19/00; H04R 1/04; H04R 1/08; H04R 1/10; H04R 3/00

(52) U.S. Cl. CPC G06F 3/162; G10L 19/00; H04R 1/04; H04R 1/08; H04R 1/1041; H04R 3/00; H04R 2420/03

(57) ABSTRACT

A digitally controlled microphone with audio compressor includes a capsule that converts sound waves into an analog audio signal; a compressor circuitry that receives and compresses the analog audio signal; a preamp positioned within the microphone body that amplifies the analog audio signal; a microphone body that encloses the compressor circuitry, capsule, and preamp; an interface that outputs the compressed digital audio signal; and an XLR connector that outputs the amplified analog audio signal. The XLR connector may enable the provision of phantom power to the preamp during an analog-only mode operation.

### RELATED APPLICATIONS

This application claims the benefit of the filing date of U.S. Patent Application No. 62/793,841, filed Jan. 17, 2019, which is incorporated herein by reference in its entirety, U.S. patent application Ser. No. 16/559,607, filed Sep. 3, 2019, which is incorporated herein by reference in its entirety, U.S. patent application Ser. No. 17/062,627, filed Oct. 4, 2020, which is incorporated herein by reference in its entirety, and U.S. patent application Ser. No. 18/106,347, filed Feb. 6, 2023, which is incorporated herein by reference in its entirety.

### BACKGROUND OF THE INVENTION

The present invention generally relates to microphones and more specifically to a digitally controlled microphone with audio compressor.

High performance microphones require immediate preamplification of the signal generated by the microphone capsule. Preamplifier performance in one area is often compromised to achieve performance in another area. For example, the needs for immunity to input noise, large output signals capable of driving large capacitive loads, insensitivity to variations in supply voltages, low power requirements, and economic design can conflict. As a result, preamplifier designs often satisfy one requirement at the expense of not satisfying other requirements.

Audio compressor amplifiers are utilized to amplify voice and/or tones to provide an output having a predetermined constant level. Radio and television broadcasting stations use audio compression and peak limiting to avoid over-modulation. Audio analog to digital converters use audio compression to achieve a more optimized conversion by reducing dynamic range as well as to prevent over modulating the convert chip which has only a finite maximum input range.

Universal Serial Bus (USB) is a standard serial interface that connects an electronic device to a computer. USB supports many types of USB connectors such as USB-A and microUSB. The Lightning™ connector can be inserted either face-up or face-down, and can be used on one end of a cable while a USB connector or another Lightning connector is used on the opposite end.

An XLR connector is a cylindrical electrical connector for analog balanced audio interconnections, with three to seven connector pins, described in international standard IEC 61076-2-103. Microphones with an XLR output connector may have a male plug that connects to a female socket of an XLR cable. XLR3 connectors for balanced audio circuits include pins for ground, positive polarity signal (“hot”), and negative polarity signal (“cold”). Phantom power is DC electric power equally applied to both signal wires in balanced microphone cables, forming a phantom circuit, to operate electronic microphones.

It would be desirable to have a microphone that combines audio compression and digital control into a small handheld device.

### SUMMARY OF THE INVENTION

In one aspect of the present invention, a digitally controlled microphone with audio compressor includes a capsule that converts sound waves into an analog audio signal; a compressor circuitry that receives and compresses the analog audio signal; a preamp positioned within the microphone body that amplifies the analog audio signal; a microphone body that encloses the compressor circuitry, capsule, and preamp; an interface that outputs the compressed digital audio signal; and an XLR connector that outputs the amplified analog audio signal.

In another aspect of the present invention, the XLR connector enables the provision of phantom power to the preamp during an analog-only mode operation.

### BRIEF DESCRIPTION OF THE DRAWINGS

FIG. 1 is a schematic diagram of an embodiment of an electric circuitry for a digitally controlled microphone with audio compressor, according to the present invention.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

An embodiment of the present invention generally provides a digitally controlled microphone with audio compressor for computer and smart phone.

Embodiments of the present invention may combine several modules that were split up into several units in the past. An embodiment may contain an audio capsule, a microphone preamplifier, an analog audio compressor, analog to digital converter, digital to analog converter, headphone amplifier, microprocessor and digital interface for Universal Serial Bus (USB) and Apple Lightning™. User adjustable controls may be of the digital controlled analog type and adjustments can be performed either through hardware controls on the device or through software controls in an application running on the connected host (such as a computer or smart phone). An embodiment may be entirely powered by a host and does not require additional external power supplies.

Embodiments may include electronic circuitry for analog processing, such as an audio compressor. Hand-held embodiments of the invention may be used for audio recording, such as voice over, singing and instrument recording. Embodiments may provide audio to a headphone jack that that combines the live audio being recorded by the microphone with audio provided by the host. Embodiments may simplify and speed up the process of audio recording by combining several elements of a recording studio into one device. Embodiments may combine miniaturized electrical components with high efficiency in power consumption into a small handheld device.

In an embodiment, the capsule and the electrical circuitry may be enclosed in a microphone body. The microphone may have a wind screen that allows sound to reach the capsule, and may have ports, controls, or connectors on the body. The body may be small enough so that the device can be easily held in the hand of a person or placed on a stand, and used as a microphone.

A notable limitation observed in conventional USB microphone applications is the absence of a mic-level analog output, thereby restricting their versatility and compatibility with certain audio systems.

Embodiments of the present invention may incorporate an XLR connector and a preamp into the microphone design. Embodiments may facilitate the provision of a reliable analog output, enhancing the microphone's functionality and adaptability. In an embodiment, an XLR connector is incorporated into the microphone, establishing a connection to output the analog signal. The preamp is positioned within the microphone housing, and amplifies the audio signal captured from the microphone capsule to enhance output quality. In an analog-only mode, the preamp may receive the unprocessed output from the microphone's capsule, apply gain to the signal, and then output the preamplified signal to the XLR connector.

Embodiments of the present invention may include a capability wherein the microphone is operated in an analog-only mode, when the XLR connector is plugged in and no USB or other connector is connected to the physical host interface for processed signals. In this mode, the microphone preamp can be efficiently powered via phantom power supplied through the XLR input.

Embodiments may incorporate an XLR connector on the microphone housing, such as an XLR3 male plug, to provide an analog output enhancement system for microphones.

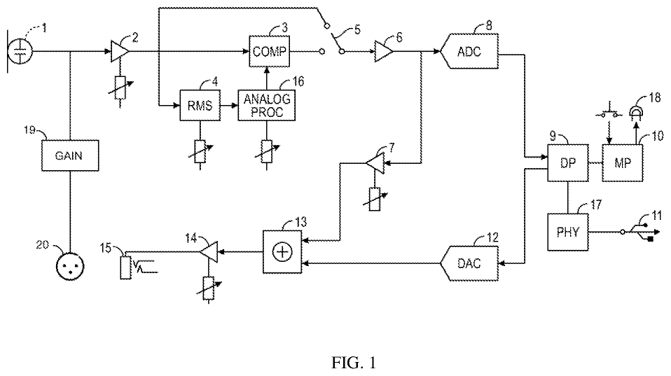

As depicted in FIG. 1, an embodiment of electrical circuitry for a microphone may include a capsule (1) that may convert sound waves into an electrical signal, which may be amplified by a digitally controlled preamplifier (2). The analog audio signal may be distributed to compressor circuitry and to a bypass switch (5) which allows for a bypass path to the compressor circuitry. The compressor circuitry may include a compressor engine (3) which compresses the audio signal and a root mean square (RMS) detector (4) which outputs a signal that is utilized by the compressor engine. In an embodiment, the sensitivity, make up and amplitude behavior/amplitude curve of the compressor engine may be voltage controlled by a digitally controlled analog processor (16) that affects the RMS output signal. Time constants affecting RMS detector behavior, such as attack and release time may be fixed, semi-automatic or digitally controlled.

Bypass switch (5) may pass the selected input to ADC drive circuitry (6), which may feed an analog signal to both digital converter (ADC) (8) and a digitally controlled preamplifier (7) for direct monitoring on headphone output. The output of ADC (8) is sent to a digital processor (9), which may be controlled by a microprocessor or MP (10). Digital processor (9) may send the audio signal and other data to a host, and receive a second digital audio signal, other data, and commands from the host with physical host interface (17) and a connector (11) using an interface protocol such as USB or Lightning™. Digital processor (9) may operate in a streaming mode, under control of microprocessor (10). Digital audio returning from the host is sent to a digital to analog converter (DAC) (12). An analog output of DAC (12) and the output of preamplifier (7) are fed into a summing circuit (13). The summing circuit (13) combines the compressed input audio signal with a second analog signal received from the host, and outputs the result to a digitally controlled headphone amplifier (14) which feeds a stereo headphone jack (15) for direct monitoring. Microprocessor 10 may send and receive control signals with several pushbuttons and LEDS 18 on the housing of the microphone.

Embodiments may include components with digital controls. The configurations for certain components may be predetermined, may be set by a host through the analog processor (16), or may be set by controls such as buttons and LEDs (18) on the microphone. An embodiment of the invention may have a number of preconfigured setups, such as three, which the user can quickly recall by clicking on controls on the unit. A software application for the host may give the user control of individual parameters. In an embodiment, the microprocessor may receive control signals from the host and then adjust parameters for the digitally controlled components.

FIG. 1 further depicts the integration of an XLR connector (20), such as an XLR3 plug, and a gain (19), which is a preamp that provides preamplification to the microphone assembly. Electrical signals from the capsule (1) are preamplified by the gain (19) and provided as an output to the XLR connector (20). The XLR connector (20) may provide phantom power to the microphone assembly.

An embodiment of a microphone may comprise: a capsule that converts sound waves into an electrical signal; a digitally controlled pre amplifier that amplifies the electric signal; a compressor engine having an audio input that receives the signal, and an RMS detector; a switch that allows for a bypass path to the compressor; an ADC driver circuitry that receives the signal; a driver having an output that feeds the signal to a digital converter; a microprocessor that controls the driver; and an interface to a bus of a host device.

I claim:

1. A microphone comprising:
a capsule that converts sound waves into an analog audio signal;
a compressor circuitry that receives and compresses the analog audio signal;
a microphone body that encloses the compressor circuitry and capsule; and
an XLR connector integrated into the microphone body for facilitating analog signal output.

2. The microphone of claim 1, further comprising a preamp positioned within the microphone body to amplify the analog audio signal.

3. The microphone of claim 2, wherein the XLR connector is an XLR3 connector for balanced audio circuits, including a male plug having pins for ground, positive polarity signal and negative polarity signal.

4. The microphone of claim 2, wherein the XLR connector enables the provision of phantom power to the preamp during an analog-only mode operation.

5. The microphone of claim 4, further comprising:
an interface that outputs the compressed digital audio signal.

6. A microphone comprising:
a capsule that converts sound waves into an analog audio signal;
a compressor circuitry that receives and compresses the analog audio signal;
a microphone body that encloses the compressor circuitry and capsule;
an XLR connector integrated into the microphone body for facilitating analog signal output; and
a preamp positioned within the microphone body to amplify the analog audio signal;
wherein the XLR connector enables the provision of phantom power to the preamp during an analog-only mode operation.

7. The microphone of claim 6, further comprising:
an interface that outputs the compressed digital audio signal.

8. A microphone comprising:
a capsule that converts sound waves into an analog audio signal;
a compressor circuitry that receives and compresses the analog audio signal;
a preamp positioned within the microphone body that amplifies the analog audio signal;
a microphone body that encloses the compressor circuitry, capsule, and preamp;
an interface that outputs the compressed digital audio signal; and
an XLR connector that outputs the amplified analog audio signal.

9. The microphone of claim 8, wherein the XLR connector enables the provision of phantom power to the preamp during an analog-only mode operation.
